(19) United States
(12) Patent Application Publication
(10) Pub. No.: US 2012/0112875 A1
(43) Pub. Date: May 10, 2012

(54) System and method for an automatic door operator having a wireless safety sensor

(76) Inventors: Liu Heng, Taiwan (CN); Yi Cheng Hsiung, Taipei Hsien (CN); Te San Liu, Taipei City (TW)

(21) Appl. No.: 13/291,570

(22) Filed: Nov. 8, 2011

Related U.S. Application Data
(60) Provisional application No. 61/411,293, filed on Nov. 8, 2010.

(51) Int. Cl. G05B 19/00

(52) U.S. Cl. 340/3.1; 340/5.7; 340/5.71

(57) ABSTRACT

A wireless safety system coupled to a door operating system which moves a door between an open and closed position relative to a fixed location. The wireless safety system includes an electric powered safety sensor assembly for detecting an obstruction between the door and the fixed location. An electric energy source is coupled to the at least one electric powered safety sensor assembly configured to generate electric energy when the door moves between the open and closed positions.

### CROSS-REFERENCE TO RELATED APPLICATIONS

This application claims priority to U.S. Patent Application Ser. No. 61/411,293 filed Nov. 8, 2010, which is incorporated herein by reference in its entirety.

### FIELD OF THE INVENTION

The present invention relates to an automatic door operator for raising and lower a door relative to a door opening, and more specifically to a system and method for operating a door operator having a self powered wireless safety sensor assembly.

### BACKGROUND OF THE INVENTION

Obstacle detection systems for door operators are well known. For example, one type of well known door operator is a garage door opener system which includes a detector that utilizes an infrared (IR) beam transmitted across the door opening and is sometimes referred to as a “beam break” unit. In this obstruction detector system, an IR emitter and IR detector are disposed on opposite sides of the door opening and the emitter sends a beam of IR pulses to the receiver. If the beam is broken by an obstruction, the garage door opener is signaled to inhibit initiation of door closure or, if the door is closing, to stop and reverse the movement of the door. It is noted other types of obstructions systems are known including a “safety edge” system which operation is dependent upon the logic signal connection of first and second wires.

Various types of automatic garage door openers have existed for many years. Conventional automatic garage door openers are electromechanical devices which raise and lower a garage door to unblock and block a garage door opening in response to actuating signals. The signals are electrical signals transmitted by closure of a push-button switch through electrical wires or by radio frequency from a battery-operated, remote controlled actuating unit. In either case the electrical signals initiate movement of the garage door from the opposite condition in which it resides. That is, if the garage door is open, the actuating signal closes it. Alternatively, when the garage door is closed, the actuating signal will open the garage door. Once movement has been initiated, the system is typically deactuated when the garage door movement trips a limit switch as the garage door approaches its open or closed position.

A noted drawback associated with conventional door operating systems, such as automatic garage door openers, is their inclusion of photo-electric safety sensors which are typically wired to a main overhead control/motor unit for providing power and signal indications to the main overhead control/motor unit. While this fully wired approach is stable, however, a significant drawback is that the wires are usually fixed to a position using staples, which leads to a problem of broken or short circuit if any staple is installed improperly thus destroying the wire. Additionally, if a staple is installed with too much pressure or misaligned with the wire, it may lead to unobservable broken or short circuit within the wire. Another drawback is the inefficiency of installation for wiring an extended wire all the way from the floor to the head unit fixed to a ceiling.

One such prior art attempt to overcome the aforesaid drawback of using wired coupled sensors is to provide a wireless coupling between the main over head control/motor unit and the sensors by using batteries as the power source of the sensors. The signal is wirelessly transmitted from the sensors to the main overhead control/motor unit typically via radio frequency (RF). However, this approach is comparatively unstable to the fully hard-wired approach since batteries have limited life cycle and eventually the sensors will come to a power outage, which will affect the operation of the head unit as a faulty or invalid signal is found on the sensors.

### SUMMARY OF THE INVENTION

In one aspect of the invention according to the illustrated embodiments is the provision of bilateral wireless connection between sensors and the head unit, while maintaining an undisturbed power source to the sensors. Electrical power to the sensors are generated by rollers coupled to a garage door, the signal from sensors to the head unit is preferably wirelessly transferred to the head unit via radio signals. Rollers are typically used for overhead sectional garage doors, which typically rotate in the door tracks along with door movement in either an opening or closing direction. The mechanically energy generated from the rollers are converted into electrical energy preferably using an electric generator coupled to each roller. The sensors are preferably low-power consumption and can be energized via a capacitor (or like energy storage component) or a rechargeable battery component. Thus the sensors are charged merely upon roller movement and therefore require no external power source. Since these sensors concern only when the door is closing, it is not necessary to have the sensors always engaged. Thus, in one embodiment of the invention, a microcontroller with extremely low power consumption (which is preferably operational to be in stand-by mode waiting for command from the head unit when a door-closing operation is triggered) is employed to enable the head unit to send an activation command to the microcontroller in the sensor whereafter the microcontroller “wakes up” the sensor so as to initiate monitoring. In another embodiment of the invention, a microcontroller coupled to the rollers is configured and operational to recognize if the door is being opened or closed by the rolling orientation of a roller so as to cause a safety sensor to be energized upon a desired door movement direction. Thereafter, if a sensor detects an obstruction relative to the moving door, a signal is sent to the head unit for appropriate control.

Thus the sensors of the instant invention according to the illustrated embodiments are easily-wired to the door rollers for undisturbed power and are operational to be in a stand-by mode when the door is not operating in a closing operation and is activated to provide safety monitoring using 2-way wireless communication with the head unit when the door is operating in a closing operation.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is a generalized perspective view of the subject invention door operating system according to an illustrated embodiment; and

FIG. 2, is a system level view of certain components of the door operating system of FIG. 1.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

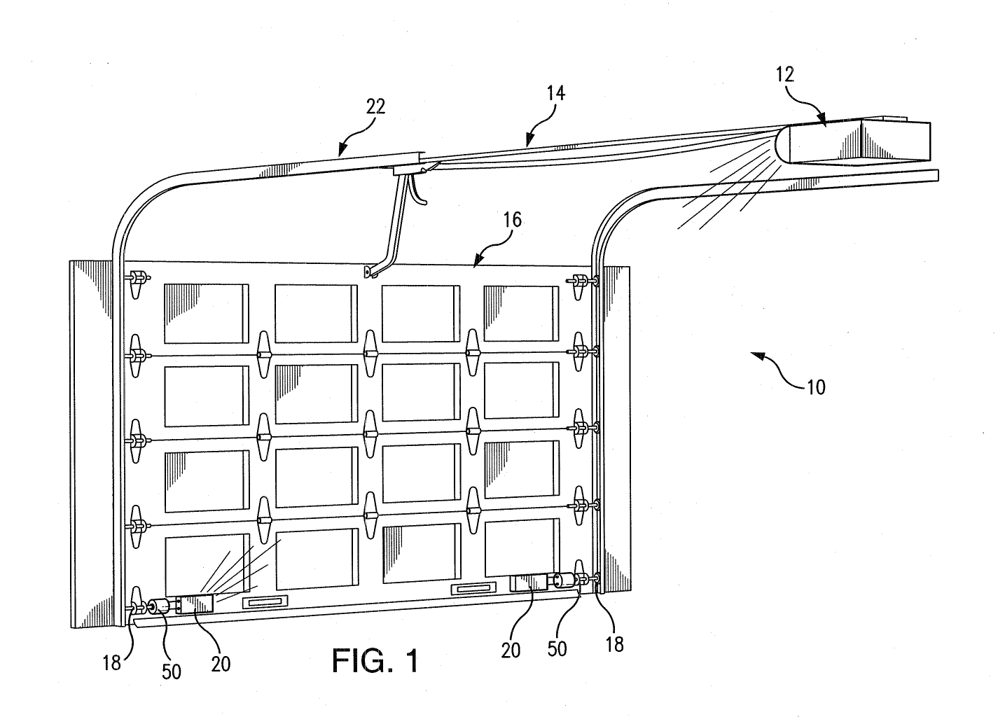

Starting with reference to FIG. 1, the present invention according to the illustrated embodiment relates to a system and method for an automatic door operator having a self-powered wireless safety sensor, designated generally by reference numeral 10. It is to be appreciated that while the system 10 is shown in FIG. 1 as be applied to a garage door operating system, system 10 is not to be understood as to be limited to such a garage door operating system but rather may be applied to any automatic door operating system using a wireless safety sensor for detecting obstructions to a moving door.

System 10 preferably includes a head unit 12 coupled to a door track assembly 14, which in turn is coupled to a door 16 (e.g., a garage door). Head unit 12 includes a motor assembly (not shown) for enabling door track assembly 14 to move door 16 between an open and closed position. Head unit 12 and coupled door track assembly 14 are to be understood to be well known in the art.

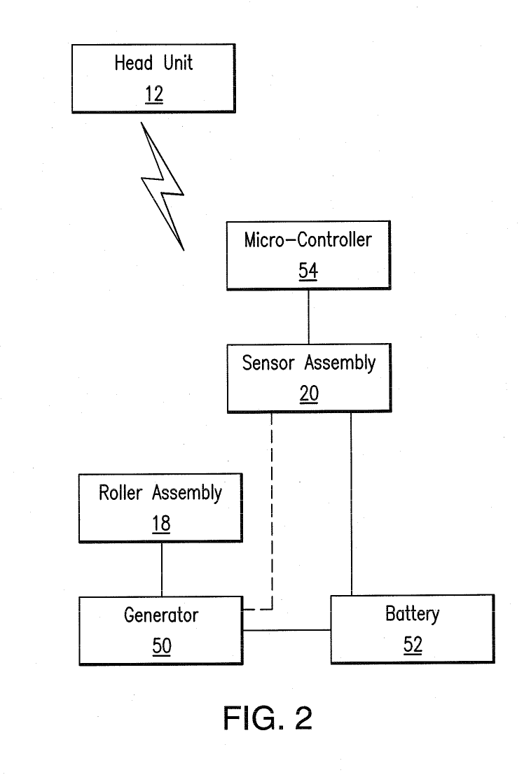

System 10 further includes according to the present illustrated embodiment, and as will be discussed in further detail below relative to FIG. 2, a roller assembly 18 preferably fixed to door 16 including at least one door roller which guides door 16 along a roller track 22 when door 16 is caused to move. Also included is a sensor assembly 20 in wireless communication with the head unit 12 detecting when an obstruction is present to door 16 when door 16 is moving. It is to be understood system 10 may include multiple roller assemblies 18 and sensor assemblies 20.

With reference now to the schematic diagram of FIG. 2, sensor assembly 20 may include any know means, such as an Infrared (IR) detector for detecting an obstruction to door 16 when opening and/or closing of door 16. Sensor assembly 20 wirelessly communicates with head unit 12 through any known means of doing so, including, but not limited to RF, Infrared, Microwave, WiFi, Z-wave, etc. Sensor assembly 20 is operational to notify head unit 12 of the presence of any obstructions to door 16 when it is either moving to an open or closed position (or one position (e.g., a closed position)) so as to trigger head unit 12 to cease movement of door 16 and/or reverse movement of door 16.

As mentioned above, roller assembly 18 includes at least one roller. This at least one roller is coupled to an electrical generator 50 (preferably mounted in proximity to the roller assembly 18) such that rotational movement of the at least one roller (caused by the opening and closing movement of door 16) imparts rotation of generator 50 enabling generator 50 to generate electrical power. As shown in FIG. 2, generator 50 may be coupled to a rechargeable battery 52 for enabling electrical charging of battery 52, which in turn provides the required electrical energy to sensor assembly 20.

Alternative to sensor assembly 20 being coupled to a rechargeable battery 52, since energization of sensor assembly 20 is only required upon movement of door 16 (which door 16 movement causes generation of electrical energy via generator 50), system 10 may include a micro-controller component 54 which detects movement of door 16 (e.g., either via roller movement or upon a signal from head unit 12) so as to then activate sensor assembly 20, which receives its electrical power from generator 50. Thus, in this illustrated embodiment, a rechargeable battery is not required.

In another illustrated embodiment of the present invention, sensor assembly 20 may include a system commonly referred to as a “safety edge” system typically including two parallel cooper wires placed against each other at the bottom of the door 16 which is an open circuit structure that will be shorted (e.g., the two wires contacting each other) once the door strikes an obstruction which short circuit then triggers the head unit 12 to cease movement of door 16. Thus, since the aforesaid “safety edge” system does not consume electrical power but rather requires an electrical source for providing high/low logic signals, the electric power generated by generator 50 will be provided to the transmitting circuitry of the sensor assembly 20 (as mentioned above) while also acting as the electrical source to the aforesaid parallel cooper wires.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention has been described, it should be understood that various changes, substitutions, and alterations can be made by one of ordinary skill in the art without departing from the scope of the present invention.

What is claimed is:

1. A wireless safety system coupled to a door operating system which moves a door between an open and closed position relative to a fixed location, the wireless safety system comprising:
an electric powered safety sensor assembly for detecting an obstruction between a door and the fixed location; and
an electric energy source coupled to the at least one electric powered safety sensor assembly configured to generate electric energy when the door moves between the open and closed positions.

2. A wireless safety system as recited in claim 1 wherein the electric energy source includes a roller assembly coupled to a door.

3. A wireless safety system as recited in claim 2 wherein the roller assembly includes an electric generator configured to generate electric energy from movement of a roller in the roller assembly when the door moves between the open and closed positions.

4. A wireless safety system as recited in claim 1 wherein the electric energy source includes a rechargeable battery for energizing the electric powered safety sensor.

5. A wireless safety system as recited in claim 1 wherein the electric energy source includes a capacitive element for energizing the electric powered safety sensor.

6. A wireless safety system as recited in claim 1 wherein the electric powered safety sensor assembly includes at least one photosensitive sensor.

7. A wireless safety system as recited in claim 1 further including a control unit remotely located and coupled to the electric powered safety sensor assembly.

8. A wireless safety system as recited in claim 7 wherein the control unit and the electric powered safety sensor assembly are each configured to wireless communicate with one another.

9. A wireless safety system as recited in claim 7 wherein the control unit is coupled to a motor coupled to a door for causing movement of a door between an open and closed position.

10. A wireless safety system as recited in claim 9 wherein the control unit is configured to stop any movement of the door to the closed position when the electric powered safety sensor assembly detects an obstruction between the door and its closed location.

11. A wireless safety system as recited in claim 7 wherein the control unit is configured to activate the electric powered safety sensor assembly upon movement of the door to the closed position.

12. A wireless safety system as recited in claim 1 wherein the electric powered safety sensor assembly includes at least one low power consumption sensing element for detecting obstructions between a door and the fixed location.

13. A method for operating a door system having a wireless safety system wherein the door moves between an open and closed position relative to a fixed location, the method including the steps of:
providing an electric powered safety sensor assembly for detecting obstructions between a door and the fixed location;
providing an electric energy source coupled to the at least one electric powered safety sensor assembly;
generating electric energy from the electric powered safety sensor assembly when the door moves between the open and closed positions; and
providing electric energy from the electric powered safety sensor assembly to the energy source.

14. A method for operating a door system having a wireless safety system as recited in claim 13 further including the steps of:
providing at least one sensing element in the electric powered safety sensor assembly for detecting obstructions between a door and the fixed location; and
energizing the at least one sensing element from the generated electric energy from the electric powered safety sensor assembly.

15. A method for operating a door system having a wireless safety system as recited in claim 14 further including the steps:
providing a control unit remotely located and coupled to the electric powered safety sensor assembly; and
wirelessly coupling the control unit to the electric powered safety sensor assembly.

16. A method for operating a door system having a wireless safety system as recited in claim 15 further including the step of stopping any movement of the door to the closed position through operation of the control unit when the electric powered safety sensor assembly detects an obstruction between the garage door and the fixed location.

17. A method for operating a door system having a wireless safety system as recited in claim 16 further including the step of activating the electric powered safety sensor assembly upon movement of the door to the closed position.

18. A garage door operating system comprising:
a motor driven garage door mechanism coupled to a garage door adapted and configured to move the garage door between an open and closed position whereby the garage door includes at least one roller assembly for facilitating movement of the garage door between the open and closed positions;
an electric power sensor or coupled to the motor driven garage door mechanism for detecting an obstruction between the garage door and a fixed location relative to the garage door; and
an electric generating device coupled to the at least one roller assembly adapted and configured to generate electric energy dependent upon movement of the at least roller assembly when the garage door is caused to move between the open and closed positions, the electric generating device being coupled to the electric powered safety sensor for providing electric energy thereto.

19. A garage door operating system as recited in claim 18 further including a micro-controller device for enabling and disabling the electric powered safety sensor in response to movement of the garage door.

20. A garage door operating system as recited in claim 18 further including a rechargeable energy source coupled to the electric generating device.
